(19) United States
(12) Patent Application Publication
(10) Pub. No.: US 2026/0139697 A1
(43) Pub. Date: May 21, 2026

(54) STRUCTURAL OBJECT

(71) Applicant: KABUSHIKI KAISHA TOKAI RIKA DENKI SEISAKUSHO, Aichi (JP)

(72) Inventors: Yuta YAMANISHI, Aichi (JP); Yosuke HATADA, Aichi (JP); Tomoki SAKAGUCHI, Aichi (JP); Akio NISHIYAMA, Aichi (JP)

(73) Assignee: KABUSHIKI KAISHA TOKAI RIKA DENKI SEISAKUSHO, Aichi (JP)

(21) Appl. No.: 19/369,699

(22) Filed: Oct. 27, 2025

(30) Foreign Application Priority Data
Nov. 21, 2024 (JP) 2024-202868

(51) Int. Cl. F16B 4/00

(52) U.S. Cl. CPC F16B 4/004

(57) ABSTRACT

To achieve inter-part fitting that makes it possible to secure a wider internal space. There is provided a structural object comprising: a first part; a second part; and an internal space that is formed by the first part and the second part, wherein the first part and the second part include tab structures that are fitted together on any one surface of an inner surface in contact with the internal space or an outer surface different from the inner surface without protruding from the surface.

### CROSS REFERENCE TO RELATED APPLICATION(S)

This application is based upon and claims benefit of priority from Japanese Patent Application No. 2024-202868, filed on Nov. 21, 2024, the entire contents of which are incorporated herein by reference.

### BACKGROUND

The present invention relates to a structural object.

In recent years, a large number of inventions relating to inter-part fitting have been reported. For example, JP 2014-84909A discloses a technology of fitting two design parts without impairing appearance quality.

### SUMMARY

In a case where a structural object including a plurality of parts includes an internal space that is formed by fitting the parts together, it is desirable to secure more space for the internal space in some cases.

Accordingly, the present invention has been devised in view of the problem above. An object of the present invention is to achieve inter-part fitting that makes it possible to secure a wider internal space.

To solve the above described problem, according to an aspect of the present invention, there is provided a structural object comprising: a first part; a second part; and an internal space that is formed by the first part and the second part, wherein the first part and the second part include tab structures that are fitted together on any one surface of an inner surface in contact with the internal space or an outer surface different from the inner surface without protruding from the surface.

As described above, the present invention makes it possible to achieve inter-part fitting that allows a wider internal space to be secured.

### BRIEF DESCRIPTION OF THE DRAWINGS

FIG. 1 is a diagram for describing an example of a conventional structural object 90.

FIG. 2 is an enlarged view of a fitting section illustrated by a chain line in FIG. 1.

FIG. 3 is a diagram for describing a structural object 10 according to an embodiment of the present invention.

FIG. 4 is a diagram illustrating a cut surface of the structural object 10 cut along A-A illustrated in FIG. 3.

FIG. 5 is an enlarged view of a fitting section illustrated by a chain line in FIG. 3.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

In addition, in a case where a plurality of components of the same type is distinguished for description in the present specification and the drawings, alphabets or the like are attached to the ends of reference sings in some cases. In contrast, in a case where there is no need to distinguish the plurality of components of the same type, the alphabets or the like are omitted and description common to all the plurality of components of the same type is made in some cases.

### 1. Embodiment

The present invention relates to a structural object including an internal space that is formed by fitting parts together. To describe an advantage of the present invention, an example of a conventional technology will be first given.

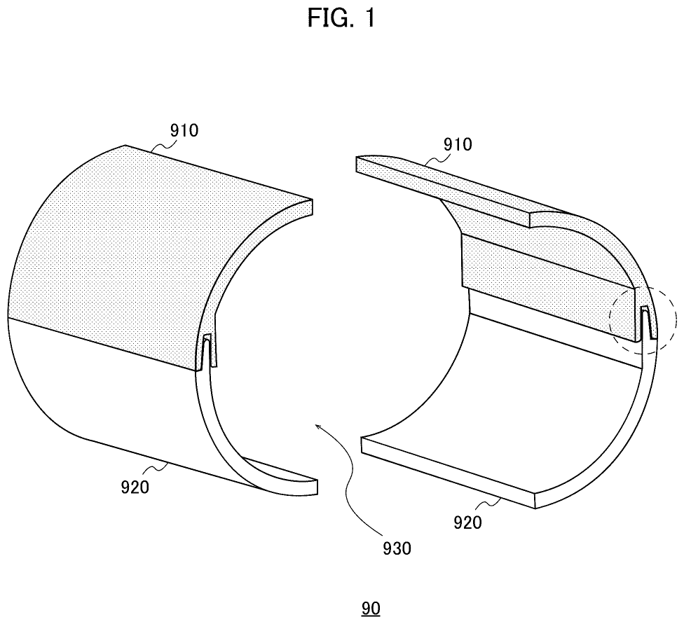

FIG. 1 is a diagram for describing an example of a conventional structural object 90.

The structural object 90 includes a first part 910 and a second part 920. In addition, the structural object 90 includes an internal space 930 that is formed by the first part 910 and the second part 920.

It should be noted that the first part 910 is illustrated in a dot pattern in the diagram to distinguish the first part 910 and the second part 920.

In addition, the first part 910 and the second part 920 are each divided in the diagram to illustrate the internal space 930 of the structural object 90 and the structure of the inner surface in contact with the internal space 930. In fact, the first part 910 and the second part 920 are, however, single parts that are each integrally formed.

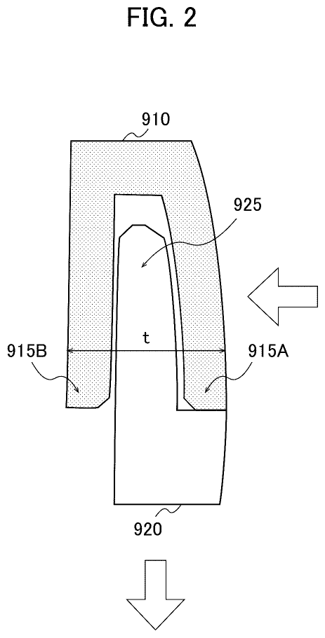

FIG. 2 is an enlarged view of the fitting section illustrated by the chain line in FIG. 1.

As illustrated in FIG. 2, the first part 910 includes two tab structures 915A and 915B. In addition, the second part 920 includes one tab structure 925.

The first part 910 and the second part 920 are fitted together such that the tab structures 915A and 915B sandwich the tab structure 925.

However, in the case of such a fitting shape, thickness t of the fitting section depends on the thickness of the tab structures 915A, 915B, and 925. The thickness t therefore tends to increase. As a result, the internal space 930 grows narrower.

In particular, in a case where another part and the like are disposed in the internal space of the structural object 90, the wider internal space 930 is requested to be secured. This leaves room for improvement in the fitting shape of the structural object 90.

In addition, the fitting shape of the structural object 90 includes a mechanism that retains the smoothness between the first part 910 and the second part 920 against external force in the horizontal direction as illustrated by the leftward arrow in the diagram, but includes no mechanism that retains the smoothness between the first part 910 and the second part 920 against external force in the vertical direction as illustrated by the downward arrow in the diagram.

For example, a separate mechanism such as a snap-fit is therefore necessary to retain the smoothness between the first part 910 and the second part 920 in the structural object 90 against the external force in the vertical direction. This makes the structure more complicated and increases the manufacturing cost.

A technical idea according to the embodiment of the present invention has been conceived by focusing on the point as described above and achieves inter-part fitting that makes it possible to secure a wider internal space in a simpler configuration.

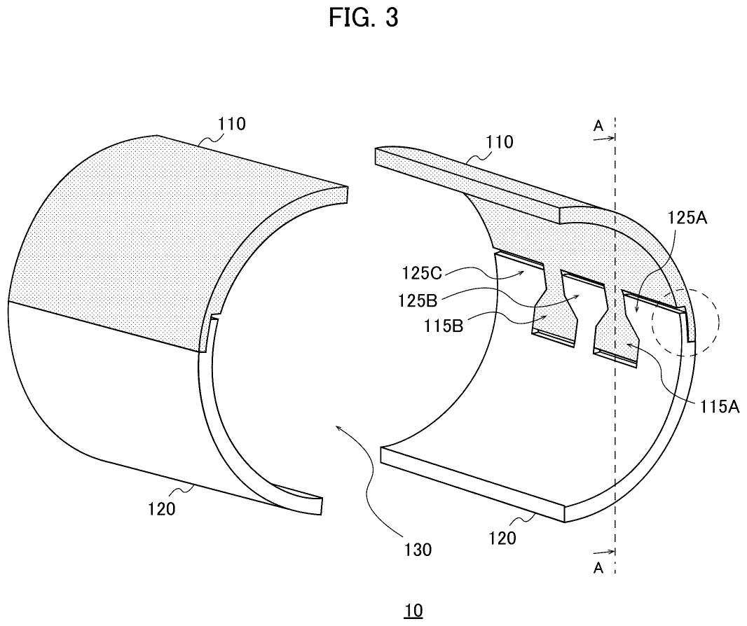

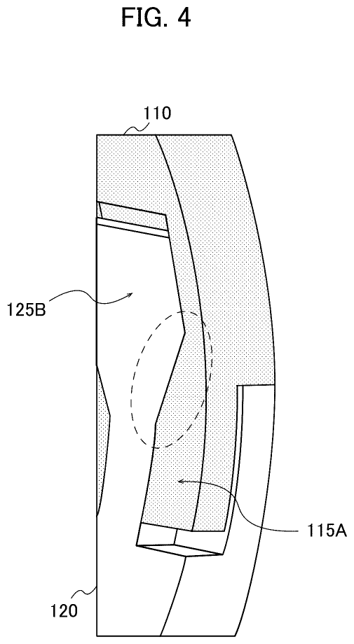

FIG. 3 is a diagram for describing a structural object 10 according to an embodiment of the present invention. In addition, FIG. 4 is a diagram illustrating a cut surface of the structural object 10 cut along A-A illustrated in FIG. 3.

As illustrated in FIG. 3, the structural object 10 according to the present embodiment includes a first part 110 and a second part 120. In addition, the structural object 10 according to the present embodiment includes an internal space 130 that is formed by the first part 110 and the second part 120.

It should be noted that the first part 110 is illustrated in a dot pattern in the diagram to distinguish the first part 110 and the second part 120.

In addition, the first part 110 and the second part 120 are each divided in the diagram to illustrate the internal space 130 of the structural object 10 and the structure of the inner surface in contact with the internal space 130. In fact, the first part 110 and the second part 120 are, however, single parts that are each integrally formed.

The first part 110 and the second part 120 according to the present embodiment have a feature that the first part 110 and the second part 120 according to the present embodiment include tab structures which are fitted together on any one surface of the inner surface in contact with the internal space 130 or the outer surface different from the inner surface without protruding from the surface.

For example, in the case of the example illustrated in FIG. 3, the first part 110 includes tab structures 115A and 115B. The second part 120 includes tab structures 125A, 125B, and 125C.

The tab structures 115A and 115B and the tab structures 125A, 125B, and 125C are fitted together on the inner surface without protruding from the inner surface.

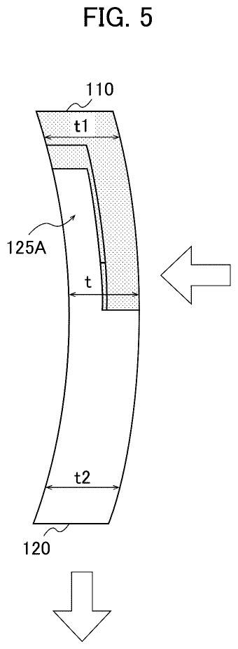

FIG. 5 is an enlarged view of the fitting section illustrated by the chain line in FIG. 3.

The fitting shape according to the present embodiment allows the thickness t of the fitting section of the structural object 10 to be equal to thickness t1 of the first part 110 and thickness t2 of the second part 120 as illustrated in FIG. 5 and makes it possible to secure the wider internal space 130 than the conventional structural object 90 does. Furthermore, it is possible to secure space for disposing another part in the internal space 130 and increase the freedom of disposition.

In addition, the fitting shape of the structural object 10 according to the present embodiment includes a mechanism that also retains the smoothness between the first part 110 and the second part 120 against external force in the vertical direction as illustrated by the downward arrow in the diagram in addition to external force in the horizontal direction as illustrated by the leftward arrow in the diagram.

The mechanism that retains the smoothness between the first part 110 and the second part 120 against the external force in the vertical direction is implemented by the tab structures 115 and 125.

For example, as illustrated by the chain line in FIG. 4, the smoothness may be guaranteed by shaping the tab structures 115A and 125B such that the tab structures 115A and 125B function as stoppers for each other against the external force in the vertical direction. The shapes of the tab structures 115 and 125 illustrated in FIGS. 3 and 4 are, however, merely examples.

As described above, it is possible for the structural object 10 according to the present embodiment to retain the smoothness between the first part 110 and the second part 120 against the external force in the horizontal direction and the external force in the vertical direction without requesting any separate mechanism such as a snap-fit and be manufactured at reduced cost.

In addition, the first part 110 and the second part 120 according to the present embodiment may be design parts.

The design parts may be parts that are exposed to the eyes of a user and requested to have appearance design in addition to functionality.

In this case, the tab structures 115 and 125 may be provided on the surface that is not exposed to the eyes of a user.

For example, in the case of the examples illustrated in FIGS. 3 to 5, the surface that is not exposed to the eyes of a user is an inner surface and the surface that is exposed to the eyes of a user is an outer surface.

Such a configuration makes it possible to achieve the fitting of the first part 110 and the second part 120 on the surface that is not exposed to the eyes of a user and secure appearance design on the surface that is exposed to the eyes of a user.

It should be noted that the structural object 10 according to the present embodiment may be mounted, for example, on a mobile body.

Examples of the mobile body include a vehicle, a vessel, an aircraft, and the like.

As an example, the structural object 10 according to the present embodiment may be each type of lever mounted on a vehicle.

The configuration example of the structural object 10 according the present embodiment has been described so far. It should be noted that the configuration described with reference to FIGS. 3 to 5 is merely an example. The configuration of the structural object 10 according to the present embodiment is not limited to the example.

For example, the structural object 10 according to the present embodiment may include another part that is fitted into both the first part 110 and the second part 120 or any one of the first part 110 or the second part 120.

In addition, the case where the first part 110 includes, for example, the two tab structures 115 and the second part 120 includes the three tab structures 125 has been exemplified above, but the number of tab structures 115 and 125 is not limited to that of the example.

It is possible to flexibly modify the configuration of the structural object 10 according to the present embodiment depending on the specifications and the like.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A structural object comprising:
a first part;
a second part; and
an internal space that is formed by the first part and the second part, wherein
the first part and the second part include tab structures that are fitted together on any one surface of an inner surface in contact with the internal space or an outer surface different from the inner surface without protruding from the surface.

2. The structural object according to claim 1, wherein the first part and the second part are design parts.

3. The structural object according to claim 2, wherein the first part and the second part include tab structures that are fitted together on the inner surface without protruding from the inner surface.

4. The structural object according to claim 1, wherein the structural object is mounted on a mobile body.
